(19) United States
(12) Patent Application Publication
(10) Pub. No.: US 2026/0077404 A1
(43) Pub. Date: Mar. 19, 2026

(54) DYNAMIC SYSTEMS AND METHODS FOR MANUFACTURING LIGHTWEIGHT METAL ALLOY ARTICLES

(71) Applicant: Estes Energy Solutions, Inc., San Francisco, CA (US)

(72) Inventors: Kassem ALHUSSEIN, Millbrae, CA (US); Dustin GRACE, San Francisco, CA (US); David LAI, San Francisco, CA (US); Cagkan YILDIZ, San Mateo, CA (US)

(21) Appl. No.: 18/887,945

(22) Filed: Sep. 17, 2024

(51) Int. Cl. B22D 21/00; B22F 1/12; B22F 9/04; C22C 1/03; H01M 50/224; H01M 50/231

(52) U.S. Cl. CPC B22D 21/007; B22F 1/12; B22F 9/04; C22C 1/03; H01M 50/224; H01M 50/231; B22F 2301/058; B22F 2302/40; B22F 2998/10; H01M 2220/20

(57) ABSTRACT

Disclosed herein are systems and methods for providing lightweight alloy articles, for example, magnesium alloy battery enclosures for electric vehicles. In some embodiments, a magnesium alloy can progress through a production line configured to chip a magnesium alloy ingot, mix the chipped alloy with additional alloying elements, and melt and mold the alloy to form a magnesium alloy metal article. The article can then be finished, coated, and joined to another magnesium article and/or to a dissimilar metal to create the magnesium alloy article.

### FIELD OF THE DISCLOSURE

The present disclosure relates generally to metal alloy article production, and more particularly the disclosure relates to lightweight metal article manufacturing for battery enclosures.

### BACKGROUND

De-carbonization initiatives continue to drive explosive growth in the worldwide production and deployment of electric vehicles. According to the International Energy Agency (IEA), the number of electric autos has risen from less than 1M cars to over 40M autos worldwide in just the last decade. This growth is not limited to autos, but extends to heavy-duty electric vehicles, such as electric buses and trucks, which have also seen tremendous growth and significant marketplace penetrations, driven in part by ongoing government mandates and regulations to reduce emissions across the globe. This worldwide growth is anticipated to continue, with the IEA forecasting that by the year 2035 there will be over 525M electric vehicles on the road worldwide.

Fundamentally important to the continued growth and deployment of electric vehicles is decreasing weight of its components generally, including the battery electrification system. Significantly decreasing the weight of battery packs and other EV components will increase efficiency through greater energy density of the electric powertrain system. While manufacturing technology for certain lightweight metals such as aluminum has advanced significantly, use of magnesium alloys for large castings is non-existent due to certain characteristics of the current magnesium alloys (such as corrosion, flammability, and low ductility), and producers' inability to address these concerns has led to very sparse use of magnesium, and a fractured and expensive manufacturing process.

Existing manufacturing methods for lightweight metal alloys such as magnesium has numerous challenges and shortcomings. In particular, streamlined manufacturing lines that can easily adapt to various design considerations based on a particular use case do not exist. Specifically, manufacturing and coating systems are not integrated, and articles made from light metal alloys such as magnesium cannot currently be manufactured from metal ingot to a completed article on a single line. Such discontinuities in the manufacturing process make the production of articles made from light metal alloys such as magnesium unnecessarily expensive and time-consuming, without real-time adaptability to adjust manufacturing parameters to different end applications.

What is more, while battery cell technology has advanced significantly, battery enclosure design has lagged. Battery enclosures are a fundamental, but perhaps a somewhat overlooked component of electric vehicles. Namely, battery enclosures, for example, in addition to providing the basic structural enclosure for the battery pack, facilitate attachment of battery packs to vehicle chassis, protect battery cells from harsh environments, provide essential safety functions, provide thermal management, and provide protections in the event of an accident. Ideally the enclosure can also support improved battery life and extend battery charge capabilities through thermo-structural control. The enclosures must achieve these objectives, while also being lightweight and durable—all at a reasonable cost to produce. Moreover, battery enclosures must come in all sizes and shapes based on the type of vehicle or other application.

Accordingly, there exists a need for such lightweight, flame resistant, and chemically inert electric vehicle battery enclosures. Moreover, the need exists for these enclosures to be manufactured with relatively low processing-related cost and high yields in manufacturing lines that readily adapt to many different product design constraints, application needs, and government regulations.

### SUMMARY

Disclosed herein are systems and methods for providing lightweight metal articles. In an embodiment the lightweight metal is a magnesium alloy and the lightweight metal article is an electric vehicle battery enclosure. In some embodiments, a metal (e.g., a metal alloy) can progress through a production line configured to chip a metal ingot, mix the chipped metal with additional alloying elements, and melt and mold the metal to form a metal article. The metal article can then be finished, coated, and joined to another metal article and/or to a dissimilar metal to create a metal article, a metal part, and/or a metal product.

Disclosed herein is a magnesium alloy article production line, including a metal breakdown apparatus configured to chip a magnesium alloy ingot into magnesium alloy pieces, a solid particle mixing apparatus configured to mix the magnesium alloy pieces with one or more powdered alloying materials to provide a mixture comprising a target magnesium alloy composition, a metal forming apparatus configured to melt the mixture into a molten magnesium alloy and urge the molten magnesium alloy into a mold to form a molded magnesium alloy article, a metal finishing apparatus configured to machine the molded magnesium alloy article to create a finished magnesium alloy article, a first coating apparatus configured to coat the finished magnesium alloy article with a first coating, and a second coating apparatus configured to coat the finished magnesium alloy article with a second coating, the second coating being different from the first coating.

In some embodiments, the one or more powdered alloying materials comprises carbon particles. In some embodiments, the metal forming apparatus is further configured to cool the molten magnesium alloy and extract the molded magnesium alloy article from the mold. In some embodiments, the metal finishing apparatus is further configured to deburr the finished magnesium alloy article. In some embodiments, the production line can include a joining apparatus configured to bond the magnesium alloy article to a different metal article, the different metal article comprising a metal composition different than the target magnesium alloy composition. In some embodiments, the second coating apparatus is configured to coat the second coating on the magnesium alloy article bonded to the different metal article. In some embodiments, the second coating is coated over the first coating. In some embodiments, the first coating apparatus is configured to selectively coat the first coating on a first portion of the finished magnesium alloy article and the second coating apparatus is configured to selectively coat the second coating on a second portion of the finished magnesium alloy article. In some embodiments, the first portion and the second portion are the same. In some embodiments, the first coating comprises a plasma electrolytic oxidation coating, a micro arc oxidation coating, a zinc phosphate coating, a fluorozirconate coating, a non-chromate conversion coating, an anodized layer, a polymeric sealant, an electrophoretic coating, a primer, a powder coating, a paint coating, an enamel coating, or a combination thereof. In some embodiments, the second coating comprises a dielectric coating. In some embodiments, the magnesium alloy article comprises an electric vehicle battery enclosure.

In some embodiments, the production line further comprises an adaptive line controller comprising an algorithm configured to control operation of at least two of the metal breakdown apparatus, the solid particle mixing apparatus, the metal forming apparatus, the metal finishing apparatus, first coating apparatus, or the second coating apparatus based on one or more target characteristics of the magnesium alloy article, wherein the one or more target characteristics of the magnesium alloy article are selected from the group consisting of: a target corrosion resistance, a target wear resistance, a target mechanical strength, a target flame resistance or retardance, a target mechanical ductility, a target cost point, and a combination thereof.

Also disclosed herein are methods of manufacturing a magnesium alloy article. In some embodiments, the method can include chipping a magnesium alloy ingot into magnesium alloy pieces, mixing the magnesium alloy pieces with one or more powdered alloying materials to provide a mixture comprising a target magnesium alloy composition, melting the mixture comprising the target magnesium alloy composition into a molten magnesium alloy, molding the molten magnesium alloy in a mold to form a molded magnesium alloy article, machining the molded magnesium alloy article to create a finished magnesium alloy article, coating at least a portion of the finished magnesium alloy article with a first coating, and coating at least a portion of the finished magnesium alloy article with a second coating, the second coating being different from the first coating. In some embodiments, the method can also include joining the magnesium alloy article to a different metal article, the different metal article comprising a metal composition different than the target magnesium alloy composition, and coating at least a portion of the magnesium alloy article and the different metal article with the first coating, the second coating, or both.

In some embodiments, the one or more powdered alloying materials comprises carbon particles. In some embodiments, the one or more powdered alloying materials are selected to produce the molten magnesium alloy having target properties for the molding operation to form the molded magnesium alloy article. In some embodiments, the first coating is selectively coated on a first portion of the finished magnesium alloy article, and the second coating is selectively coated on a second portion of the finished magnesium alloy article. In some embodiments, the method further includes masking the second portion of the finished magnesium alloy article while coating the first coating. In some embodiments, the second coating is coated over the first coating. In some embodiments, machining the molded magnesium alloy article includes one or more shaping steps and one or more drilling steps, and wherein process parameters of the one or more shaping steps and the one or more drilling steps are selected based on the target magnesium alloy composition. In some embodiments, the first coating and the second coating are selected based on a target surface property for a first portion of the finished magnesium alloy article. In some embodiments, the target surface property is a wear resistance, a corrosion resistance, a dielectric strength, or a combination thereof. In some embodiments, the second coating is coated over the first coating on a first portion of the finished magnesium alloy article, and the method further includes coating a second portion of the finished magnesium alloy article with a third coating and a fourth coating coated over the third coating, and the first coating and the second coating are selected based on a first target surface property for the first portion of the finished magnesium alloy article, and the third coating and the fourth coating are selected based on a second target surface property for the second portion of the finished magnesium alloy article, and the first target surface property is different than the second target surface property. In some embodiments, the magnesium alloy article comprises an electric vehicle battery enclosure.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a schematic illustration showing a magnesium alloy metal article production line, according to some embodiments.

FIG. 2 is a flowchart illustrating a process for manufacturing a magnesium alloy metal article, according to some embodiments.

FIG. 3 is a schematic illustration showing a metal breakdown apparatus, according to some embodiments.

FIG. 4 is a schematic illustration showing a solid particle mixing apparatus, according to some embodiments.

FIG. 5 is a schematic illustration showing a metal forming apparatus, according to some embodiments.

FIG. 6 is a flowchart illustrating a process for providing a magnesium alloy metal article, according to some embodiments.

FIG. 7 is a schematic illustration showing a metal finishing apparatus, according to some embodiments.

FIG. 8 is a schematic illustration showing a coating apparatus, according to some embodiments.

FIG. 9 is a schematic illustration showing a metal joining apparatus, according to some embodiments.

FIG. 10 is a magnesium alloy battery enclosure, according to some embodiments.

FIG. 11 is a first part of a magnesium alloy battery enclosure, according to some embodiments.

FIG. 12 is a second part of a magnesium alloy battery enclosure, according to some embodiments.

FIG. 13 illustrates an example computer system useful for implementing various embodiments.

It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

Described herein is a production line for providing a metal article (e.g., a metal part, a metal product, a metal piece, or the like). The design of production lines according to embodiments described herein, and the corresponding methods of manufacturing, enable manufacturing that is agnostic to the metal or metal alloy being processed. The design of production lines according to embodiments described herein, and the corresponding methods of manufacturing, are adaptable to the metal or metal alloy being processed and target article characteristics for a production run of one or multiple articles. In an embodiment, the lightweight metal article made by the manufacturing line is an electric vehicle battery enclosure.

For example, a metal alloy ingot can be broken down into small pieces (e.g., solid metal/alloy particles) that can be mixed with further alloying elements to optimize the physical characteristics of the metal alloy. The small pieces and additional alloying elements can then be melted and molded to a predetermined shape (e.g., a desired shape of the metal article based on its intended application). The molded metal alloy can then be finished (e.g., machined, deburred, and/or cleaned) and coated (e.g., for corrosion resistance and/or electrical insulation), and optionally joined to another metal article. The design and operation of these processes performed in the production line according to embodiments described herein can be agnostic to the metal alloy chemistry and/or the predetermined shape of the metal article (e.g., the application for which the metal article will be employed), due at least to each operation performed in the production line being tailorable to the metal chemistry and intended application of the metal article. In particular embodiments described herein, the design of production lines according to embodiments described herein, and the corresponding methods of manufacturing, enable magnesium alloy article manufacturing that is agnostic to the type of magnesium alloy being processed. In some embodiments, the manufacturing process can be controlled by an adaptive line controller comprising an algorithm configured to tailor operational parameters of multiple steps within the production line based on input of metal alloy ingot properties, target article characteristics, or a combination thereof.

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “comprising” and “including” are open-ended transitional phrases. A list of elements following the transitional phrase “comprising” or “including” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

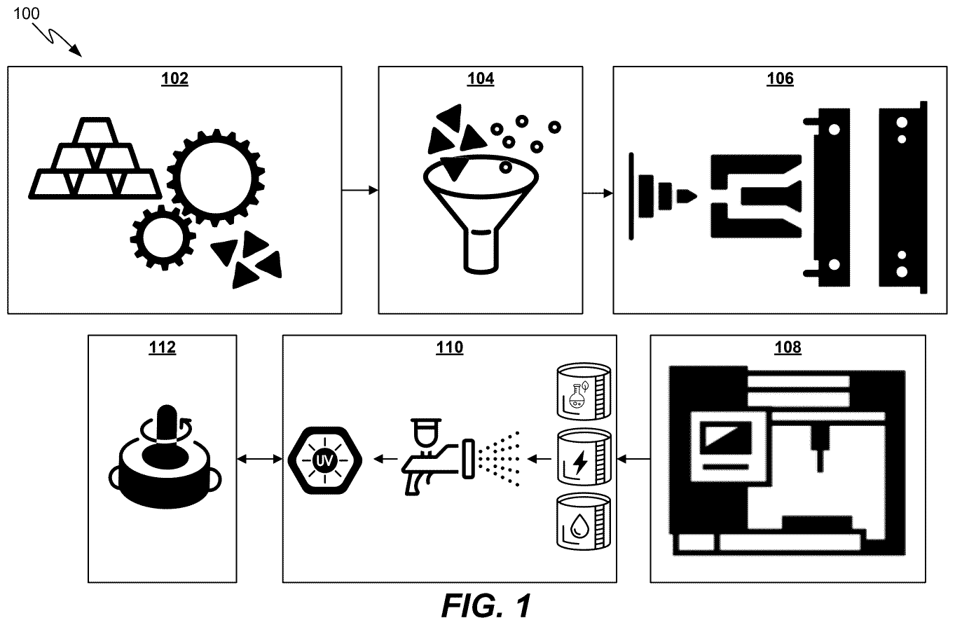

Referring to the drawings in general and to FIG. 1 in particular, it will be understood that the illustrations are for the purpose of describing particular embodiments and are not intended to limit the disclosure appended claims thereto. The drawings are not necessarily to scale, and certain features and certain views of the drawings may be shown exaggerated in scale or in schematic form in the interest of clarity and conciseness.

As used herein, unless specified otherwise, references to “first,” “second,” “third,” “fourth,” etc. are not intended to denote order, or that an earlier-numbered feature is required for a later-numbered feature. Also, unless specified otherwise, the use of “first,” “second,” “third,” “fourth,” etc. does not necessarily mean that the “first,” “second,” “third,” “fourth,” etc. features have different properties or values.

FIG. 1 illustrates a production line 100 for manufacturing a magnesium alloy metal article, according to some embodiments. In some embodiments, production line 100 can include a metal breakdown apparatus 102, a solid particle mixing apparatus 104, a metal forming apparatus 106, a metal finishing apparatus 108, a coating apparatus 110, and/or a joining apparatus 112. Each of metal breakdown apparatus 102, solid particle mixing apparatus 104, metal forming apparatus 106, metal finishing apparatus 108, coating apparatus 110, and/or joining apparatus 112 be can located at the same location. For example, in some embodiments, each of metal breakdown apparatus 102, solid particle mixing apparatus 104, metal forming apparatus 106, metal finishing apparatus 108, coating apparatus 110, and/or a joining apparatus 112 be can located on the same manufacturing floor within a manufacturing facility, or on multiple manufacturing floors with the same manufacturing facility. In some embodiments, each of metal breakdown apparatus 102, solid particle mixing apparatus 104, metal forming apparatus 106, metal finishing apparatus 108, coating apparatus 110, and/or joining apparatus 112 be can located in multiple facilities (e.g., metal breakdown apparatus 102, solid particle mixing apparatus 104, and metal forming apparatus 106 can be located in a first facility and metal finishing apparatus 108, coating apparatus 110, and joining apparatus can be located in a second facility).

In some embodiments, a magnesium alloy can progress through production line 100 in a continual manner, for example, without storage time that can allow for unintentional age hardening. In some embodiments, the magnesium alloy can move through this process with minimal time between each operation, as described in further detail below. For example, the magnesium alloy can be chipped into smaller pieces, the smaller pieces can then be mixed with additional alloying elements to provide a mixture having a targeted magnesium alloy composition, the mixture can be melted, cast in a mold and cooled to provide a magnesium alloy metal article. Then, the magnesium alloy metal article can be finished and coated.

In some embodiments, the article can be joined to another magnesium article and/or to a dissimilar metal article (i.e., a different metal article having a different composition from the target magnesium alloy metal article composition). In some embodiments, the article can be coated before being joined to another magnesium article and/or to a dissimilar metal article. In some embodiments, the article can be coated after being joined to another magnesium article and/or to a dissimilar metal article. In some embodiments, a first portion of the article can be coated before being joined to another magnesium article and/or to a dissimilar metal article, and a second portion of the article can be coated after being joined to another magnesium article and/or to a dissimilar metal article.

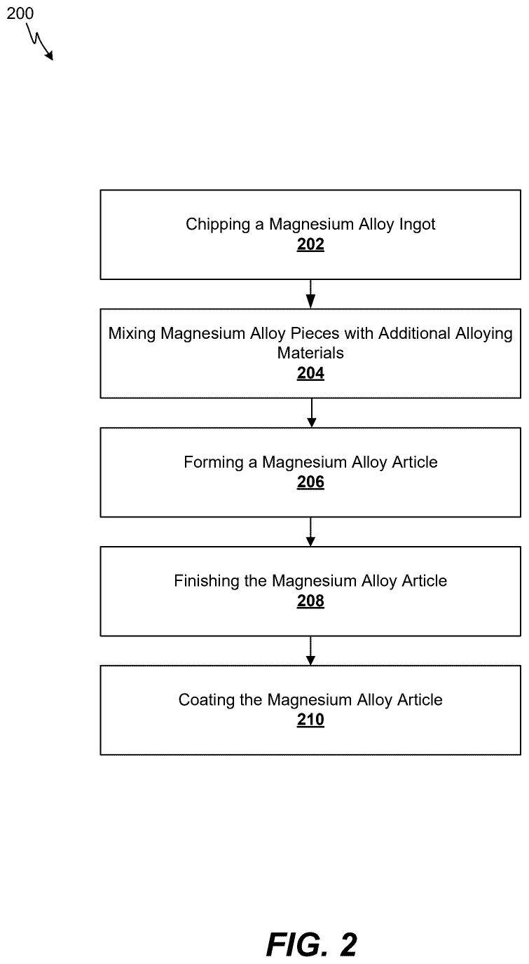

FIG. 2 illustrates a method 200 for producing a magnesium alloy metal article according to some embodiments. Method 200 can be performed by the processing apparatuses of production line 100. It is to be appreciated that not all steps may be needed to perform method 200 and manufacture a metal article as disclosed herein. Further, some of the steps can be performed simultaneously, or in a different order than shown in FIG. 2, as will be understood by a person of ordinary skill in the art.

For illustrative and non-limiting purposes, method 200 is described with reference to FIGS. 1 and 3-13. However, method 200 is not limited to those examples.

In operation 202, a magnesium alloy ingot can be broken down (e.g., chipped, shredded, milled, and/or cut) into smaller pieces to provide a plurality of solid particles 324. In some embodiments, the solid particles 324 can have a particle size (e.g., a diameter, a lateral dimension, or the like) ranging from 500 microns (μm) to 10 millimeters (mm). For example, the solid particles 324 can have a particle size ranging from 1 mm to 10 mm, from 750 μm to 9 mm, from 1.5 mm to 9.5 mm, from 5 mm to 10 mm, from 500 μm to 5 mm, or from 900 μm to 9.5 mm.

In some embodiments, the magnesium alloy of the ingot can be an AZ63 magnesium alloy, an AZ81 magnesium alloy, an AZ91 magnesium alloy, an AM20 magnesium alloy, an AM50 magnesium alloy, an AM60 magnesium alloy, an AE42 magnesium alloy, an AS41 magnesium alloy, a ZK51 magnesium alloy, a ZK61 magnesium alloy, a ZE41 magnesium alloy, a ZC63 magnesium alloy, an HK31 magnesium alloy, an HZ32 magnesium alloy, a QE22 magnesium alloy, a QH21 magnesium alloy, a WE54 magnesium alloy, a WE43 magnesium alloy, an AZ31 magnesium alloy, an AZ61 magnesium alloy, an AZ80 magnesium alloy, a ZK60 magnesium alloy, an M1A magnesium alloy, an HK31 magnesium alloy, an HM21 magnesium alloy, a ZE41 magnesium alloy, a ZC71 magnesium alloy, a ZM21 magnesium alloy, an AM40 magnesium alloy, a K1A magnesium alloy, an M1 magnesium alloy, a ZK10 magnesium alloy, a ZK20 magnesium alloy, a ZK30 magnesium alloy, and/or a ZK40 magnesium alloy.

In some embodiments, any of the above listed magnesium alloy types for the ingot can be further alloyed with calcium, yttrium, or both. In some embodiments, the magnesium alloy can include a calcium concentration from 0.02 wt % to 2.5 wt %. In some embodiments, the magnesium alloy can include a yttrium concentration from 0.02 wt % to 2.5 wt %. In some embodiments, the magnesium alloy can include a beryllium concentration from 0.0005 wt % to 0.015 wt %.

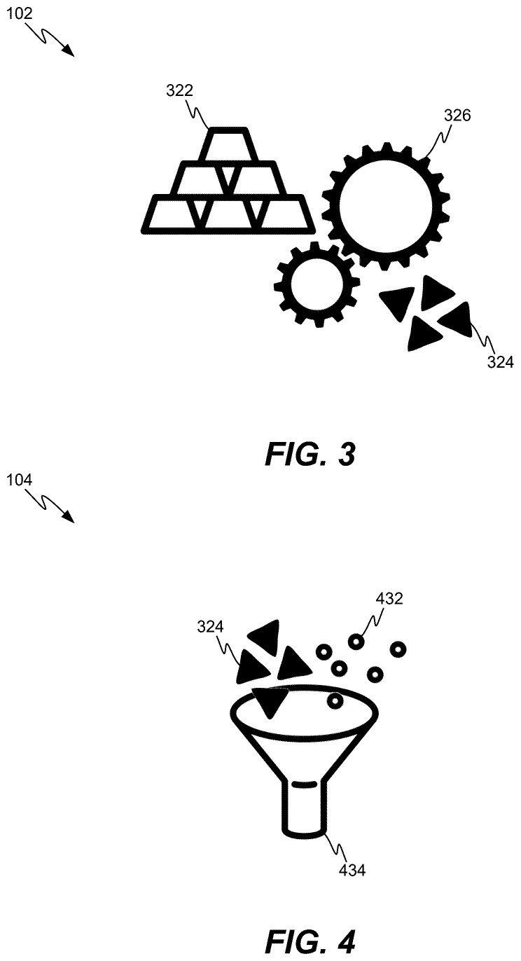

In some embodiments and exemplified in FIG. 3, metal breakdown apparatus 102 can chip magnesium alloy ingots 322 into a plurality of solid magnesium alloy particles 324. For example, in some embodiments, metal breakdown apparatus 102 can include a grinder 326 configured to chip magnesium alloy ingots 322 into a plurality of solid magnesium alloy particles 324. In some embodiments, after chipping, the plurality of solid magnesium alloy particles 324 can be screened for uniform chip size and to remove any fine or oversized pieces. In some embodiments, a uniform particle size can facilitate a precise alloy mixture (e.g., a precise addition of C to the magnesium alloy particles 324).

In some embodiments, the plurality of solid magnesium alloy particles 324 can be stored in containers that prevent water adsorption, contamination, and/or oxidation before being fed into the mixing apparatus 104 during mixing operation 204 or the forming operation 206. In some embodiments, the plurality of solid magnesium alloy particles 324 can be directly fed into the mixing apparatus 104 during mixing operation 204 or the forming operation 206. In such embodiments, directly feeding the plurality of solid magnesium alloy particles 324 into the mixing operation 204 or forming operation 206 can avoid a chip collection safety hazard and/or can mitigate water adsorption, preventing corrosion and unwanted aging.

In operation 204, particles 324 can be mixed with one or more further alloying elements 432 to provide a mixture comprising a target magnesium alloy composition. In such embodiments, the one or more further alloying elements 432 can be powdered alloying particles. In some embodiments, the one or more further alloying elements can be powdered carbon (C), aluminum (Al), bismuth (Bi), copper (Cu), cadmium (Cd), iron (Fe), thorium (Th), strontium (Sr), zirconium (Zr), lithium (Li), manganese (Mn), nickel (Ni), lead (Pb), silver (Ag), chromium (Cr), silicon (Si), tin (Sn), gadolinium (Gd), yttrium (Y), calcium (Ca), antimony (Sb), zinc (Zn), beryllium (Be) and/or various rare earth elements. In some embodiments, the one or more further alloying elements can be a powder, an aggregate, a core-shell particle powder/dispersion, or any solid particle known to those of skill in the art. In some embodiments, the one or more further alloying elements can be silicon or silicon oxide particles, boron or boron oxide particles, a ceramic powder, or rare earth metal particles. In some embodiments, the one or more alloying elements can be polymer derived (e.g., carbon particles having a polymer shell, polymer particles that are decomposed during melting leaving carbon in the mixture, recycled tires, or the like).

In some embodiments and exemplified in FIG. 4, the plurality of solid magnesium alloy particles 324 can be mixed with carbon particles 432. For example, carbon particles 432 can be carbon black, activated carbon black, graphite, graphene, activated charcoal, carbon nanotubes, fullerene, carbon nanofibers, carbon nanohorns, nanodiamond, or carbon-based quantum dots (QDs) particles, or any combination thereof. In such embodiments, adding carbon particles 432 can be tailored to provide a magnesium alloy having desired characteristics (e.g., mechanical properties). For example, a dispenser for the carbon particles 432 (or any other powdered alloying particle) can, by way of a computer system described herein, add precise amounts of the particles 432 to provide a magnesium alloy having tailored properties, including tensile strength, fatigue strength, and flowability during forming.

In some embodiments, the further alloying element particles (e.g., carbon particles 432) can have a particle size ranging from 10 nm to 1,500 nm, from 25 nm to 1,000 nm, from 15 nm to 1,000 nm, from 25 nm to 1,500 nm, from 10 nm to 1,000 nm, from 100 nm to 1,000 nm, from 250 nm to 1,000 nm, or from 500 nm to 1,000 nm.

In some embodiments, a further alloying element (e.g., carbon particles 432,) can be added to provide a magnesium alloy having up to 5% of the alloying element by weight (w/w), for example, from 0.1 wt % to 5 wt %, from 0.5 wt % to 5 wt %, from 0.5 wt % to 0.45 wt %, from 1 wt % to 4 wt %, from 0.1 wt % to 3 wt %, or from 0.1 wt % to 2 wt %. In some embodiments, multiple further alloying elements can each be added at any of these weight percent ranges. In some embodiments, carbon is not added to the magnesium alloy (e.g., 0% C) in operation 204.

Mixing apparatus 104 can include any suitable solid particle mixing device 434. For example, in some embodiments, mixing device 434 can include a funnel, a feed screw, a ball mill, a rotary drum, a magnetic stir system, a mixing paddle, or any combination thereof. In some embodiments, a heated feed screw can be used to concomitantly mix and melt magnesium alloy solid particles 324 and the one or more further alloying elements to provide a molten mixture of magnesium alloy solid particles and the one or more further alloying elements. In some embodiments, mixing apparatus 104 can include a mixing system according to PCT Application Publication No. WO 2023/079027 A1.

The design of mixing operation 204 as described herein can enable a production line 100 and method 200 that is agnostic to the magnesium alloy chemistry and/or the predetermined shape of the magnesium alloy metal article (e.g., the application for which the magnesium alloy metal article will be employed). For example, magnesium alloys having reduced elongation before fracture (e.g., AZ91D) can become brittle when alloyed with Ca and/or Y to make the magnesium alloy flame retardant. Carbon can be added during the mixing in operation 204 to maintain formability in downstream processing. In some embodiments, the amount, size, and/or shape of carbon particles 432 (or any other powered alloying element described herein) can be tailored to provide a magnesium alloy having predetermined mechanical properties during formation, in the final magnesium alloy article, or both.

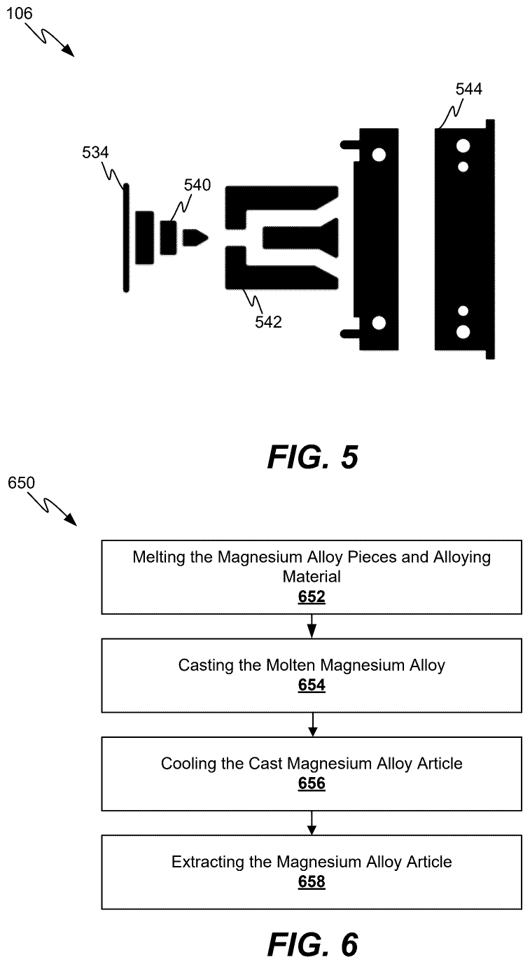

In operation 206, the mixture provided in operation 204 can be melted into a molten magnesium alloy and the molten magnesium alloy can be urged into a mold to form a molded magnesium alloy article. In some embodiments, the forming can include a thixo system (e.g., a thixotropic piston injection molding system, a thixomolding system, or a thixocasting system), a rheocasting system, or any magnesium forming operation known to those of skill in the art. In operation 206, the molten mixture of melted magnesium alloy solid particles and the one or more alloying elements can be fed into a forming apparatus 106. In some embodiments, the forming apparatus 106 can include an input 534, a feed screw 540, a mold 542, and a press 544, as exemplified in FIG. 5. In some embodiments, press 544 can be a giga-press. In some embodiments, input 534 can be a heated funnel configured to at least partially melt magnesium alloy solid particles 324 and mix the one or more alloying elements into the molten magnesium alloy. In some embodiments, the fed screw can be heated, to melt the magnesium alloy solid particles 324 and mix the one or more alloying elements into the molten magnesium alloy.

In some embodiments, a thixo system can be configured to provide geometrically complex magnesium alloy metal articles via a molding process. In other examples, the thixo system can provide magnesium alloy metal articles have a wall thickness of less than 2 mm (e.g., the thixo process can provide magnesium alloy metal articles having a wall thickness of from 1.5 mm to 10 mm).

In some embodiments, forming apparatus 106 can be configured to provide large format magnesium alloy metal articles (e.g., magnesium alloy metal articles having a mass ranging from 10 kg to 75 kg). In some embodiments, press 544 can include a die-casting press configured to form and cool the magnesium alloy metal article. Accordingly, in operation 656, press 544 can be cooled to cool the formed magnesium alloy metal article. Cooling press 544 can be performed by any one of liquid cooling, emulsion cooling, bath immersion, liquid spray cooling, air cooling, forced air cooling, or any cooling operation known to those of skill in the art.

In some embodiments, the forming process can be performed according to the method 650 illustrated in FIG. 6. For example, in operation 652, magnesium alloy solid particles 324 and the one or more alloying elements can be melted and/or mixed and melted as described previously. After melting the solid mixture including the target magnesium alloy composition (e.g., the mixed magnesium alloy solid particles 324 and the one or more alloying elements), the molten mixture can be urged (e.g., fed) into mold 542 in operation 654. In some embodiments, mold 542 can be pretreated with a demolding agent to facilitate extraction of a molded metal article after molding and cooling. For example, a process robot can apply the demolding agent before the molten mixture is fed into mold 542. Feeding the molten mixture into mold 542 can comprise any suitable molding operation for forming a molded magnesium alloy article. For example, feeding the molten mixture into mold 542 can include pouring, injecting, casting, blowing, compressing, or a combination thereof.

In some embodiments, the molding process in operation 654 can be performed at a temperature ranging from 570° C. to 645° C. (e.g., from 575° C. to 640° C., from 580° C. to 645° C., or from 585° C. to 640° C.).

Mold 542 can have any shape predetermined by the target application for the magnesium alloy metal article. For example, mold 542 can be configured to provide transportation industry parts, defense industry parts, or any industrial application amenable to employing a magnesium alloy metal article. Accordingly, mold 542 can include any geometry that is target application specific. In some embodiments, mold 542 can be configured to mold a battery enclosure part, for example base 1130 or cap 1240 as described herein.

In some embodiments, forming apparatus 106 (e.g., the thixo system combined with the giga-press system) can be configured to provide a magnesium alloy metal article having a mass of less than or equal to 75 kilograms (kg). For example, forming apparatus 106 can be configured to provide a magnesium metal article having a mass from 1 kg to 75 kg, from 0.5 kg to 70 kg, from 0.1 kg to 75 kg, from 5 kg to 70 kg, or from 5 kg to 72.5 kg. In some embodiments, forming apparatus 106 can be configured to provide a single magnesium alloy metal article of up to 75 kg or a plurality of magnesium alloy metal articles totaling up to 75 kg (e.g., three magnesium alloy metal articles of up to 25 kg each, ten magnesium alloy metal articles of up to 7.5 kg, or any combination of magnesium metal articles totaling up to 75 kg.

In some embodiments, the thixo system can convert solid particles into a semi-solid slurry that can inject the molten magnesium alloy into mold 542. In some embodiments, a larger mold 542 can use press 544 (e.g., a giga-press) to hold mold 542 in place with sufficient pressure.

After cooling, the magnesium alloy metal article can be extracted from mold 542 in operation 658. In some embodiments, production line 100 can comprise one or more robots to handle extracting the magnesium alloy metal article from mold 542. For example, a first robot can spray mold 542 with a demolding agent. In some embodiments, based on the alloy chemistry, the demolding agent is determined and optimized. Additionally, a spray duration and pre-programmed spray topology can be applied based on the magnesium alloy chemistry. For example, some magnesium alloy chemistries can adhere to the mold based on the surface characteristics of the magnesium alloy. In some embodiments, the demolding agent recipe can be tailored to downstream processing. For example, the amount of demolding agent applied can be varied based on the potential need for a degreasing step in subsequent operations. In further examples, the demolding agent recipe can be tailored to specific magnesium alloy applications (e.g., complex battery enclosures, simple magnesium rods, etc.). After application of the demolding agent, a second robot can grab the magnesium alloy metal article and apply a demolding motion. After extracting the article from mold 542, the magnesium alloy metal article can be transferred to the finishing apparatus 108. In some embodiments, after extracting the magnesium alloy metal article, the first robot can apply a demolding agent to prepare for a next forming operation 206, 650.

In some embodiments, the magnesium alloy metal article can be trimmed and cleaned after extraction from mold 542. For example, a die cutting tool can be used to remove any magnesium alloy flash occurring at molten mixture influx points and/or areas where separate mold 542 parts form a seam.

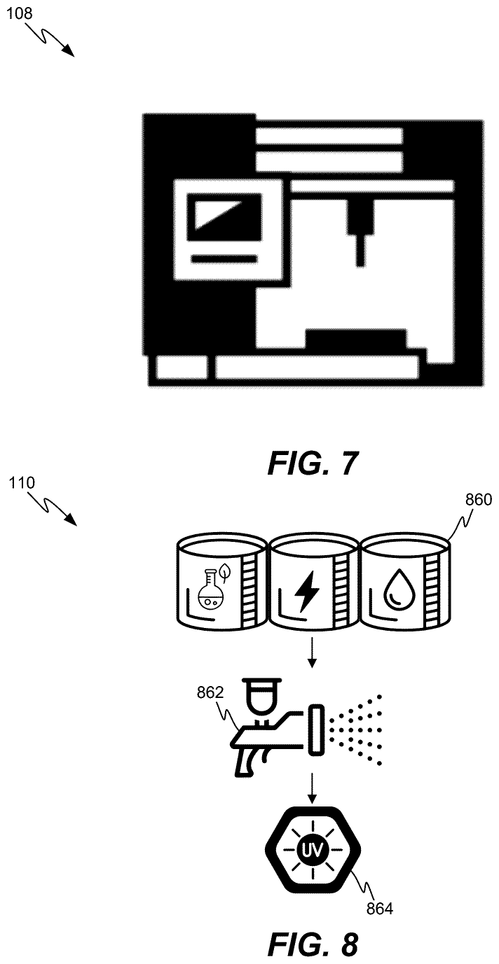

After forming, the formed magnesium alloy metal article can be machined in a finishing apparatus 108 in operation 208. Finishing apparatus 108 is configured to machine the molded magnesium alloy article to create a finished magnesium alloy article. In some embodiments, finishing apparatus 108 can include a computer numerical control (CNC) machine used for final geometry finishing of the article as shown in FIG. 7. In some embodiments, CNC machining can configure the magnesium alloy metal article to its respective application. Using CNC to configure the magnesium alloy metal article can reduce and/or eliminate the need for additional molds and/or casts. For example, a CNC machine can be used to shape a molded magnesium alloy into a predetermined magnesium alloy metal article (e.g., a magnesium alloy final product and/or a magnesium alloy metal part).

In some embodiments, the CNC tooling and speed can be optimized according to magnesium alloy chemistry and/or magnesium alloy metal article application. For example, tooling speed (e.g., drill speed, milling speed, router speed, cutting blade speed, grinding speed, polishing speed, or any CNC machining mechanism known to those of skill in the art) can be tailored to accommodate the magnesium alloy ductility, tensile strength, compression strength, softness, or the like. For example, a brittle magnesium alloy can be subjected to slow tool speeds (e.g., slow drilling, slow routing) to avoid fracturing the magnesium alloy. Additionally, in some embodiments a coolant can be applied to the magnesium alloy during finishing to avoid thermally-induced fracture and/or fatigue occurring in the magnesium alloy metal article and/or the machining tool. As such, the finishing apparatus (e.g., the CNC machine) can be controlled according to the mechanical properties of the magnesium alloy metal article.

In some embodiments, the CNC finishing operation 208 can at least partially prepare surfaces of the magnesium alloy metal article for downstream processing, including coating and joining. For example, the finishing apparatus (e.g., a CNC machine) can be used to remove baked-on demolding agent, deburr the magnesium alloy metal article, or degrease the magnesium alloy metal article.

In operation 210, the finished magnesium alloy metal article is coated with one or more surface coatings. In some embodiments, the coating operation 210 can be performed according to the predetermined application of the magnesium alloy metal article (e.g., land transportation, marine applications, or aerospace applications). In some embodiments, operation 210 can include multiple coating operations.

Operation 210 can be performed by one or more coating apparatuses 110, as exemplified in FIG. 8. For example, line 100 can include a first coating apparatus 110a and a second coating apparatus 110b. In some embodiments, line 100 can include more than two coating apparatuses 110.

Exemplary coatings that can be applied by coating apparatus(es) 110 include, but are not limited to, a surface treatment coating (e.g., a plasma electrolytic oxidation (PEO) coating, a micro arc oxidation coating, a zinc phosphate coating, a fluorozirconate coating, a ceramic coating, a non-chromate conversion coating (NCCC), or an anodized magnesium oxide layer), a primer and/or adhesion promoter (e.g., an acrylic primer, or a zinc-chromate primer), a polymeric sealant (e.g., a polyurethane, an epoxy, or silicone coating), a finishing coating (e.g., a powder coating, a paint (e.g., an acrylic paint) or an enamel), a dielectric coating (e.g., an acrylic film), or any combination thereof. In some embodiments, the polymeric sealant can be coated using an electrophoretic deposition (e-coat) process.

In some embodiments, operation 210 can include multiple coating processes. For example, a first coating process can coat the magnesium alloy metal article with a surface treatment coating that imparts surface properties specifically to the magnesium alloy, e.g., corrosion resistance, flame suppression, and/or wear resistance. In some embodiments, in a subsequent coating processes (e.g., a second coating process), the magnesium alloy metal article can be coated with the dielectric coating, an additional corrosion inhibitor, and/or an additional primer/adhesion promoter. In some embodiments, operation 210 can comprise a coating process that applies a primer/adhesion promoter after the surface treatment coating. In some embodiments, operation 210 can comprise a coating process that applies a sealant after the surface treatment coating. In some embodiments, operation 210 can comprise a coating process that applies a sealant and a primer/adhesion promoter after the surface treatment coating. In some embodiments, the dielectric coating can be applied after the sealant, the primer/adhesion promoter, or both.

In some embodiments, the first coating process can be performed by a first coating apparatus 110a, and a second coating can be performed by a second coating apparatus 110b. For example, the first coating apparatus 110a can apply a surface treatment coating (e.g., a PEO coating), and the second coating apparatus 110b can apply a dielectric coating (e.g., an acrylic coating). In embodiments comprising multiple coating apparatuses 110, each coating apparatus 110 can be optimized for a specific coating, including spray on coatings, roll on coatings, pour over coatings (e.g., enrobing), electrically/electronically applied coatings (e.g., e-coat, powder coat, electroplating, etc.), or any coating technique known to those of skill in the art.

In some embodiments, a coating apparatus 110 can include coating tanks 860, a coating applicator 862, and a curing apparatus 864. For example, coating applicator 862 can include a sprayer, a bath, a roll coater, a robing coater, a powder coater, an electroplating system, or an electrophoretic coating system (e-coat). In some embodiments, curing apparatus 864 can include an ultraviolet (UV) light curing system, a furnace, a forced-air drying system, an air-drying system, a heated air drying system, or any combination thereof.

In some embodiments, any number of coating apparatuses can be used depending on the types and quantity of coatings predetermined for the intended application of the magnesium alloy metal article. As a non-limiting example, a first coating apparatus 110 can be configured to apply a surface treatment coating, and a second coating apparatus can be configured to apply a polymeric sealant, a third coating apparatus can be configured to apply a primer/adhesion promoter, and a fourth coating apparatus can be configured to apply a dielectric coating, and fifth coating apparatus can be configured to apply a finishing coating (e.g., a powder coating).

In some embodiments, a coating recipe (a combination of coatings applied by one or more coating apparatuses 110) can be varied based on the magnesium alloy composition and/or the intended application for the magnesium alloy metal article. For example, a marine application can require extra corrosion resistance either by applying multiple corrosion inhibitor layers, thicker corrosion inhibitor layers, or a combination thereof. For example, a first surface treatment coating applied during the first coating process can passivate the magnesium alloy, generate a corrosion protection layer, and/or provide adhesion to magnesium and for subsequent layers. A second coating applied during the second coating process can seal the corrosion protection layer (e.g., a polymeric sealant applied via e-coating to both seal and provide protection against moisture, chemicals or other contaminating agents). A third coating applied during the third coating process can protect the underlying coating layers by adding wear resistance (e.g., by powder coating and/or an acrylic coating).

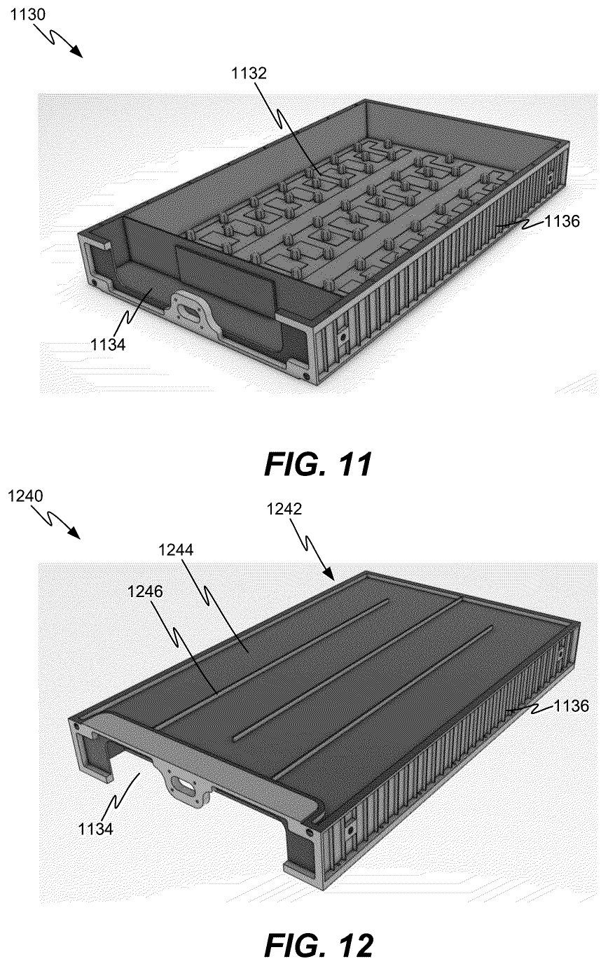

In some embodiments, the coatings can be selectively coated onto different portions of the magnesium alloy metal article. For example, a first portion of the magnesium alloy metal article (e.g., an exterior surface, such as exterior surface 1136 in FIGS. 11 and 12) can be coated with a first coating (e.g., a surface treatment coating), a second portion of the magnesium alloy metal article (e.g., an interior surface, such as battery bay 1132 in FIG. 11) can be coated with a dielectric coating. In some embodiments, the first portion and the second portion can be the same portion. In some embodiments, the first portion and the second portion can overall each other. In some embodiments, coating different portions of the magnesium alloy metal article with different coatings can be performed by masking or by precise control using a computer-controlled coating system. In some embodiments, the coatings, or lack thereof, can be selected based on the magnesium alloy chemistry. For example, for an AM50 magnesium alloy, a type of surface treatment coating that adheres well to the AM50 magnesium alloy can be selected to provide target surface property(ies) (e.g., wear resistance, corrosion resistance, dielectric strength, or a combination thereof).

In some embodiments, a second coating can be coated over the first coating on a first portion of the finished magnesium alloy article. In some embodiments, a second portion of the finished magnesium alloy article can be coated with a third coating and a fourth coating coated over the third coating. For example, the first coating and the second coating can be selected based on a first target surface property for the first portion of the finished magnesium alloy article, and the third coating and the fourth coating can be selected based on a second target surface property for the second portion of the finished magnesium alloy article. In some embodiments, the first target surface property can be different than the second target surface property. The first coating, second coating, third coating, and fourth coating can each be selected from a surface treatment coating, a polymeric sealant, a primer/adhesion promoter, a finishing coating, and a dielectric coating as described herein. In some embodiments, a portion of the finished magnesium alloy article (for example, an exterior surface, such as exterior surface 1136) can be coated with each of a surface treatment coating, a polymeric sealant, a primer/adhesion promoter, a finishing coating, and a dielectric coating.

In some embodiments, the coating thickness for any of a surface treatment coating, a polymeric sealant, a primer/adhesion promoter, a finishing coating, or a dielectric coating can range from 500 nanometers (0.5 μm) to 1 mm (1,000 μm). For example, the coatings can have a thickness ranging from 2 μm to 500 μm, from 4 μm to 250 μm, from 5 μm to 150 μm, from 10 μm to 500 μm, from 5 μm to 500 μm, from 4 μm to 500 μm, or from 15 μm to 500 μm. In some embodiments, any one of the coatings can have a thickness of 0.5 μm, 1 μm, 2 μm, 3 μm, 4 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 205 μm, 210 μm, 215 μm, 220 μm, 225 μm, 230 μm, 235 μm, 240 μm, 245 μm, 250 μm, 255 μm, 260 μm, 265 μm, 270 μm, 275 μm, 280 μm, 285 μm, 290 μm, 295 μm, 300 μm, 305 μm, 310 μm, 315 μm, 320 μm, 325 μm, 330 μm, 335 μm, 340 μm, 345 μm, 350 μm, 355 μm, 360 μm, 365 μm, 370 μm, 375 μm, 380 μm, 385 μm, 390 μm, 395 μm, 400 μm, 405 μm, 410 μm, 415 μm, 420 μm, 425 μm, 430 μm, 435 μm, 440 μm, 445 μm, 450 μm, 455 μm, 460 μm, 465 μm, 470 μm, 475 μm, 480 μm, 485 μm, 490 μm, 495 μm, 500 μm, 550 μm, 600 μm, 650 μm, 700 μm, 750 μm, 800 μm, 850 μm, 900 μm, 950 μm, 1,000 μm, or any range having any two of these values as end points (e.g., from 0.5 μm to 495 μm, from 1 μm to 650 μm, from 2 μm to 10 μm, or from 2 μm to 490 μm).

In some embodiments, the one or more coating apparatuses 110 can apply different coatings to different portions of the magnesium alloy metal article during operation 210. For example, a first portion of the magnesium article can be coated with a surface treatment coating, a second portion of the magnesium alloy metal article can be with a surface treatment coating and a primer/adhesion promoter, and a third portion of the magnesium alloy metal article can be coated with a surface treatment coating, a polymeric sealant, and a primer/adhesion promoter. In other words, the one or more coating apparatuses can apply different coatings on one portion of the magnesium alloy metal article.

In some embodiments, the one or more coating apparatuses 110 can apply different coatings to different portions of the magnesium alloy metal article during operation 210 such that the coatings are disposed over each other on different portion of the article. For example, a first portion of the magnesium article can be coated with a surface treatment coating, a second portion of the magnesium alloy metal article can be with the surface treatment coating and a primer/adhesion promoter, and a third portion of the magnesium alloy metal article can be coated with the surface treatment coating, a polymeric sealant, and the primer/adhesion promoter.

For example, a coating recipe applied can include a surface treatment coating, a sealant, and a primer/adhesion promoter. In some embodiments, the surface treatment coating can be coated onto at least a first portion of the magnesium alloy metal article at a thickness ranging from 1 μm to 15 μm (e.g., from 2 μm to 10 μm, from 1.5 μm to 12.5 μm, from 3 μm to 9 μm, or from 1 μm to 10 μm). In some embodiments, the sealant can be coated onto all or a portion of the surface treatment coating to cover porosity in the surface treatment coating and/or protect the surface treatment coating from wear. In some embodiments, the sealant can be coated at a thickness of from 0.5 μm to 30 μm (e.g., from 5 μm to 25 μm, from 1 μm to 29 μm, from 10 μm to 15 μm, from 5 μm to 15 μm, from 10 μm to 30 μm, or from 0.75 μm to 28 μm). In some embodiments, the primer/adhesion promoter can be coated onto all or a portion of the surface treatment coating and all or a portion of the sealant. In some embodiments, the primer/adhesion promoter can be coated at a thickness of up to 50 μm (e.g., from 1 μm to 40 μm, from 5 μm to 40 μm, from 0.1 μm to 50 μm, from 1 μm to 50 μm, or from 1 μm to 35 μm).

In some embodiments, a finishing coating and/or a dielectric coating can be coated over all or a portion of the surface treatment coating, all or a portion of the sealant, and/or all or a portion of the primer/adhesion promoter. In some embodiments, the dielectric coating can be coated at a thickness of from 100 μm to 750 μm (e.g., from 150 μm to 500 μm, from 125 μm to 600 μm, from 100 μm to 500 μm, from 100 μm to 250 μm, from 250 μm to 750 μm, or from 100 μm to 700 μm). In some embodiments, the finishing coating can be coated at a thickness of from 25 μm to 100 μm (e.g., from 30 μm to 100 μm, from 40 μm to 100 μm, from 50 μm to 100 μm, from 25 μm to 75 μm, or from 25 μm to 50 μm).

In some embodiments, coating recipes can be tailored to the magnesium alloy chemistry to provide predetermined physical characteristics (e.g., mechanical properties) and other material properties to various portions of the article. For example, combining magnesium alloy chemistry with a tailored coating method can provide optimized corrosion resistance, wear resistance, strength, ductility (measured in percent elastic elongation), and cost. For example, a marine application could require high corrosion resistance and a strong dielectric constant. An aerospace application could require medium strength, high elongation for in-air vibration resistance, high corrosion resistance, and a medium wear resistance. Various portions of the article that can be coated with different coatings as described herein include a first portion (e.g., bay 1132 of enclosure 1090), a second portion (e.g., bay 1134 of enclosure 1090), a third portion (e.g., coolant channels 1244 of enclosure 1090), and fourth portion (e.g., exterior surface 1136 of enclosure 1090).

The coating in operation 210 can be performed at any point after the finishing in operation 208. For example, the magnesium alloy metal article can be coated in the first coating process, joined to a dissimilar metal article (e.g., an aluminum ally article), and additionally coated in the second coating process. In some cases, the magnesium alloy article can be coated in the first and second coating process before being joined to another metal article (e.g., a dissimilar metal article and/or another magnesium alloy metal article). In other examples, the magnesium alloy metal article can be joined before any coating processes (e.g., the magnesium article can be joined to another metal article and subsequently coated in the first and/or second coating processes).

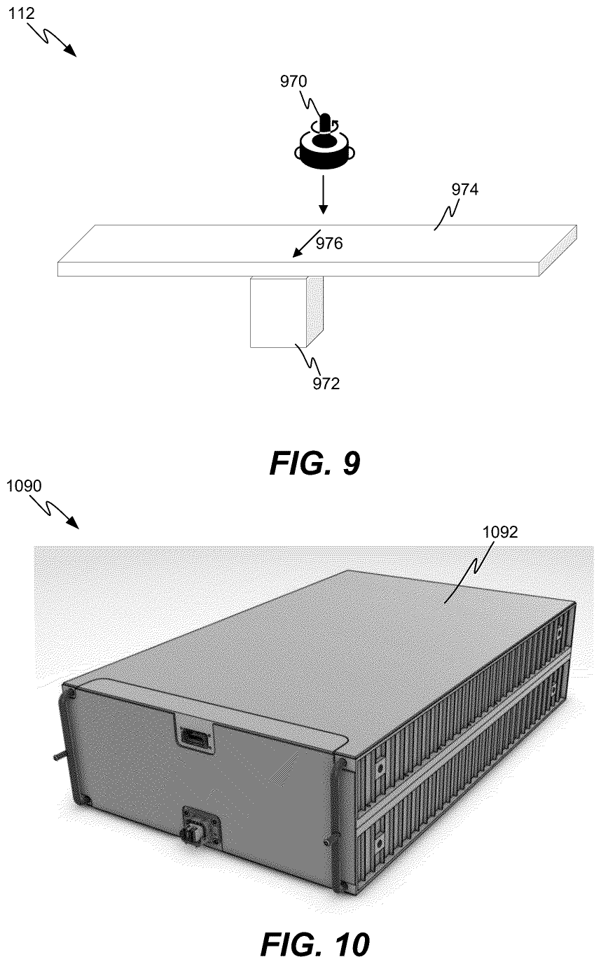

Optionally, in some embodiments, method 200 can include a joining operation. For example, the joining operation can be used to join two or more magnesium alloy metal articles, or a magnesium alloy metal article to a dissimilar metal article. In some embodiments, production line 100 can include a friction stir welding (FSW) joining apparatus 112, as exemplified in FIG. 9. In such embodiment, FSW is a solid-state metal joining procedure that does not melt the metals being joined. As such, the FSW apparatus can grind and amalgamate the two respective surfaces of the metal articles being joined.

In some embodiments, joining apparatus 112 can include a FSW tool 970 configured to join two dissimilar metal articles (e.g., magnesium alloy metal article 972 and an aluminum alloy metal article 974) in a perpendicular configuration. For example, FSW tool 970 can be rotated and lowered to aluminum alloy article 974, engaging the teeth of FSW tool 970 in aluminum alloy article 974. FSW tool 970 can be further lowered such that FSW tool 970 penetrates through aluminum alloy article 974 and at least partially into magnesium alloy metal article 972. The rotation of FSW tool 970 can churn and amalgamate aluminum alloy article 974 and magnesium alloy metal article 972 to begin a weld. After beginning the weld, FSW tool 970 can be urged along a weld path 976 to provide the joined metal article. In some embodiments, the dissimilar metal article 974 can be a protective cover 1092 of battery enclosure 1090.

In some embodiments, the joined metal article can be coated following the joining operation. For example, the first coating can be coated onto the magnesium alloy article before the joining operation by the first coating apparatus, and a second coating can be coated onto the joined metal article by the second coating apparatus. In some embodiments, the second coating can be applied over the first coating. In some embodiments, the second coating can be applied adjacent to the first coating.

In some embodiments, line 100 can be controlled by an adaptive line controller configured to control operation of at least two of the metal breakdown apparatus 102, the solid particle mixing apparatus 104, the metal forming apparatus 106, the metal finishing apparatus 108, the first coating apparatus 110a, and the second coating apparatus 110b based on one or more target characteristics of the magnesium alloy article. In such embodiments, the one or more target characteristics for a production run of one or multiple articles can be input into the adaptive line controller, and an algorithm of the adaptive line controller sets operational parameters of the metal breakdown apparatus 102, the solid particle mixing apparatus 104, the metal forming apparatus 106, the metal finishing apparatus 108, the first coating apparatus 110a, or the second coating apparatus 110b based on the input target characteristic(s). In some embodiments, one or more properties of the starting magnesium alloy (e.g., properties of the ingot(s)) can additionally be input into the adaptive line controller, and the algorithm can be configured to set operational parameters of the metal breakdown apparatus 102, the solid particle mixing apparatus 104, the metal forming apparatus 106, the metal finishing apparatus 108, the first coating apparatus 110a, or the second coating apparatus 110b based on properties of the starting magnesium alloy.

Exemplary target characteristics of the magnesium alloy article include, but are not limited to, a target corrosion resistance for the article, a target wear resistance for the article, a target mechanical strength for the article, a target flame resistance or retardance, a target mechanical ductility for the article, a target cost point for the article, or a combination thereof. Exemplary properties of the starting magnesium alloy include, but are not limited to, alloy composition, wear resistance, mechanical strength, mechanical ductility, formality, flammability, or a combination thereof.

Exemplary operational parameters of the metal breakdown apparatus 102 that can be set by the algorithm of the adaptive line controller comprise the particle size of solid particles 324 produced by the metal breakdown apparatus.

Exemplary operational parameters of the solid particle mixing apparatus 104 that can be set by the algorithm of the adaptive line controller comprise the type of the one or more further alloying elements 432, the wt % of the one or more further alloying elements 432, and a particle size of the one or more further alloying elements 432. In some embodiments, the algorithm of the adaptive line controller can control one or more of these operational parameters based on the magnesium alloy chemistry of the alloy ingot chipped by the metal breakdown apparatus 102 and the target characteristic(s) of the article. In such embodiments, the algorithm of the adaptive line controller can tailor the operational parameters of the solid particle mixing apparatus 104 to produce a mixture that can be formed by metal forming apparatus 106 to form an article comprising the target mechanical strength and/or the target mechanical ductility for the article. For example, the algorithm can tailor the operational parameters of the solid particle mixing apparatus 104 to produce a mixture having processing characteristics (e.g., formability characteristics) tailored to the operational parameters of the metal forming apparatus 106.

Exemplary operational parameters of the metal forming apparatus 106 that can be set by the algorithm of the adaptive line controller comprise a molding temperature profile, a molding pressure, a cooling temperature profile, and a demolding agent selection.

Exemplary operational parameters of the metal finishing apparatus 108 that can be set by the algorithm of the adaptive line controller comprise one or more machine tooling speeds (e.g., drill speed, milling speed, router speed, cutting blade speed, grinding speed, polishing speed) and a coolant application procedure. In some embodiments, the algorithm of the adaptive line controller can control one or more of these operational parameters based on the magnesium alloy chemistry of the alloy ingot(s) chipped by the metal breakdown apparatus 102 and the target characteristic(s) of the article. In such embodiments, the algorithm of the adaptive line controller can tailor the operational parameters of the metal finishing apparatus 108 based on input mechanical properties of the alloy in the ingot(s). For example, the algorithm can select a tooling speed based on the mechanical ductility of the magnesium alloy.

Exemplary operational parameters of the first coating apparatus and/or the second coating apparatus (or any additional coating apparatuses in line 100) that can be set by the algorithm of the adaptive line controller comprise coating thickness, coating type, and the portion(s) of the article coated by a particular coating. In addition, the algorithm of the adaptive line controller can control the number and the order of coatings applied (i.e., the coating recipe applied) to the article with the first coating apparatus, the second coating apparatus, and any additional coating apparatuses in line 100. In such embodiments, the algorithm of the adaptive line controller can be configured to adapt the coating recipe to the target characteristic(s) of the article and the magnesium alloy chemistry of the alloy from which the article is made. In some embodiments, the algorithm of the adaptive line controller can be configured to select a coating recipe tailored to the alloy ingot chipped by the metal breakdown apparatus and the target characteristic(s) of the article. For example, the algorithm can be configured to select (i) a first coating recipe for a first alloy type (e.g., an AZ91 magnesium alloy) and target characteristics for a marine battery application and (ii) a second coating recipe for a second alloy type (e.g., an AM50 magnesium alloy) and target characteristics for an automotive battery application. As another example, the algorithm can be configured to select (i) a first coating recipe for a first alloy type (e.g., an AZ91 magnesium alloy) and target characteristics for a marine battery application and (ii) a second coating recipe for a second alloy type (e.g., an AM50 magnesium alloy) and target characteristics for the same marine battery application.

FIG. 10 illustrates a battery enclosure 1090 that can be manufactured by the systems and methods described herein. Battery enclosure 1090 can be an electric vehicle battery enclosure. For example, and as illustrated in FIGS. 11 and 12, components of battery enclosure 1090 can be produced according to method 200. In some embodiments, FIG. 11 illustrates a base 1130 of a battery enclosure that can include a battery bay 1132, an ancillary bay 1134, and an exterior surface 1136. In some embodiments, as described previously, each of battery bay 1132, ancillary bay 1134, and exterior surface 1136 can receive similar and/or different coatings during the coating in operation 210. For example, in a first series of coating processes, battery bay 1132 can be coated with a surface treatment coating, a polymeric sealant and/or a primer/adhesion promoter. Then, in a second coating process, battery bay 1132 can be coated with a dielectric coating.

In some embodiments, ancillary bay 1134 can be coated with the surface treatment coating, the polymeric sealant, and/or the primer/adhesion promoter in the first series of coating processes, and a dielectric coating in the second coating procedure. In some embodiments, exterior surface 1136 can be coated with the surface treatment coating, the polymeric sealant, and/or the primer/adhesion promoter in the first series of coating processes, and a dielectric coating in the second coating procedure.

FIG. 12 illustrates a cap 1240 of battery enclosure 1090, including exterior surface 1136 and ancillary bay 1134. In some embodiments, cap 1240 can also include a coolant bay 1242 that can include coolant channels 1244 and coolant channel walls 1246. In some embodiments, coolant channel walls 1246 can also serve as a point where an aluminum alloy cover (e.g., protective cover 1092) can be friction stir welded to cap 1240 of battery enclosure 1090 produced as the magnesium alloy metal article by the systems and methods described herein. In some embodiments, coolant channels 1244 can be coated with the surface treatment coating, the polymeric sealant, and/or the primer/adhesion promoter in the first series of coating processes, and a dielectric coating in the second coating procedure.

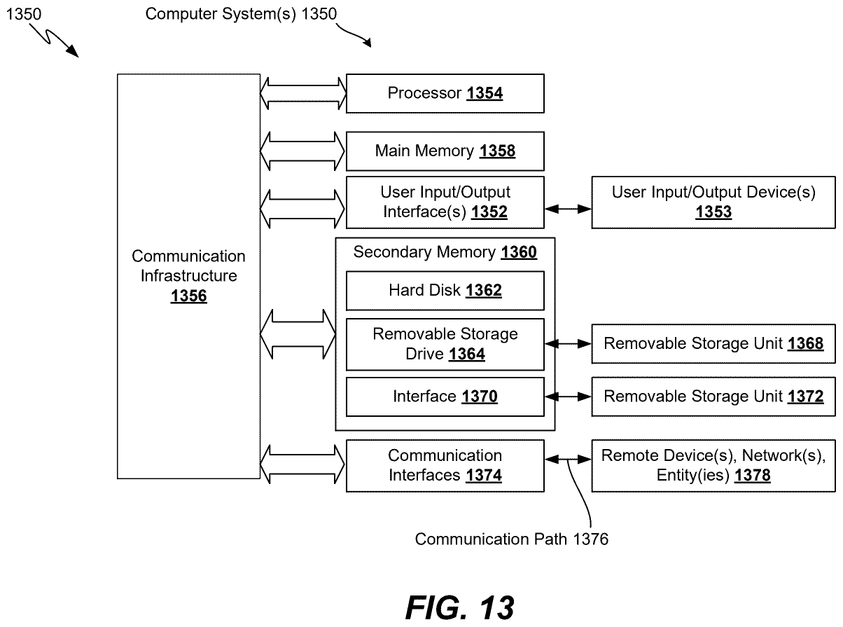

Various embodiments can be implemented, for example, using one or more well-known computer systems, such as a computer system 1350 shown in FIG. 13. For example, the magnesium alloy production line 100 can be implemented using combinations or sub-combinations of the computer system 1350. Also or alternatively, one or more computer systems 1350 can be used, for example, to implement any of the embodiments discussed herein, as well as combinations and sub-combinations thereof. Exemplary features of production line 100 that can be implemented using combinations or sub-combinations of the computer system 1350 include, but are not limited to, the adaptive line controller, powdered alloy element introduction in a solid particle mixing apparatus 104, CNC machining in metal finishing apparatus 108, and coating parameters in coating apparatuses 110.

Computer system 1350 can include one or more processors (also called central processing units, or CPUs), such as a processor 1354. Processor 1354 can be connected to a communication infrastructure (or bus) 1356.

Computer system 1350 can also include user input/output device(s) 1353, such as monitors, keyboards, pointing devices, etc., which can communicate with communication infrastructure 1356 through user input/output interface(s) 1352.

One or more of processors 1354 can be a graphics processing unit (GPU). In an embodiment, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 1350 can also include a main or primary memory 1358, such as random access memory (RAM). Main memory 1358 can include one or more levels of cache. Main memory 1358 can have stored therein control logic (i.e., computer software) and/or data.

Computer system 1350 can also include one or more secondary storage devices or memory 1360. Secondary memory 1360 can include, for example, a hard disk drive 1362 and/or a removable storage device or drive 1364. Removable storage drive 1364 can be a floppy disk drive, a magnetic tape drive, a compact disk drive, an optical storage device, tape backup device, and/or any other storage device/drive.

Removable storage drive 1364 can interact with a removable storage unit 1368. Removable storage unit 1368 can include a computer usable or readable storage device having stored thereon computer software (control logic) and/or data. Removable storage unit 1368 can be a floppy disk, magnetic tape, compact disk, DVD, optical storage disk, and/any other computer data storage device. Removable storage drive 1364 can read from and/or write to removable storage unit 1368.

Secondary memory 1360 can include other means, devices, components, instrumentalities or other approaches for allowing computer programs and/or other instructions and/or data to be accessed by computer system 1350. Such means, devices, components, instrumentalities or other approaches can include, for example, a removable storage unit 1372 and an interface 1370. Examples of the removable storage unit 1372 and the interface 1370 can include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1350 can further include a communication or network interface 1374. Communication interface 1374 can enable computer system 1350 to communicate and interact with any combination of external devices, external networks, external entities, etc. (individually and collectively referenced by reference number 1378). For example, communication interface 1374 can allow computer system 1350 to communicate with external or remote devices 1378 over communications path 1376, which can be wired and/or wireless (or a combination thereof), and which can include any combination of LANs, WANs, the Internet, etc. Control logic and/or data can be transmitted to and from computer system 1350 via communication path 1376.

Computer system 1350 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1350 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1350 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some embodiments, a tangible, non-transitory apparatus or article of manufacture comprising a tangible, non-transitory computer useable or readable medium having control logic (software) stored thereon can also be referred to herein as a computer program product or program storage device. This includes, but is not limited to, computer system 1350, main memory 1358, secondary memory 1360, and removable storage units 1368 and 1372, as well as tangible articles of manufacture embodying any combination of the foregoing. Such control logic, when executed by one or more data processing devices (such as computer system 1350 or processor(s) 1354), can cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

The described magnesium alloy articles and processes can be advantageously employed in the transportation industry, including, but not limited to, automotive manufacturing, truck manufacturing, manufacturing of ships and boats, manufacturing of trains, airplanes, and spacecraft manufacturing. The term “automotive” and the related terms as used herein are not limited to automobiles and include various vehicle classes, such as, automobiles, cars, buses, motorcycles, marine vehicles, off highway vehicles, light trucks, trucks, or lorries. However, magnesium alloy articles are not limited to automotive parts; other types of magnesium articles manufactured according to the processes described in this application are envisioned. For example, the described processes can be advantageously employed in manufacturing of various parts of mechanical and other devices or machinery, including tools, bodies of electronic devices, and other parts and devices.

The magnesium alloy articles and processes described herein can also be used in electronics applications, to prepare, for example, external and internal encasements. For example, the alloys and methods described herein can also be used to prepare enclosures for electronic devices, including mobile phones and tablet computers. In some examples, the alloys can be used to prepare enclosures for the outer casing of mobile phones (e.g., smart phones) and tablet bottom chassis.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the metals, alloys, production methods, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “some embodiments,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of this disclosure should not be limited by any of the above-described exemplary embodiments, but should be defined only in accordance with the following claims and their equivalents.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A magnesium alloy article production line, comprising:
a metal breakdown apparatus configured to chip a magnesium alloy ingot into magnesium alloy pieces;
a solid particle mixing apparatus configured to mix the magnesium alloy pieces with one or more powdered alloying materials to provide a mixture comprising a target magnesium alloy composition;
a metal forming apparatus configured to melt the mixture into a molten magnesium alloy and urge the molten magnesium alloy into a mold to form a molded magnesium alloy article;
a metal finishing apparatus configured to machine the molded magnesium alloy article to create a finished magnesium alloy article;
a first coating apparatus configured to coat the finished magnesium alloy article with a first coating; and
a second coating apparatus configured to coat the finished magnesium alloy article with a second coating, the second coating being different from the first coating.

2. The magnesium alloy article production line of claim 1, wherein the one or more powdered alloying materials comprises carbon particles.

3. The magnesium alloy article production line of claim 1, wherein the metal forming apparatus is further configured to cool the molten magnesium alloy and extract the molded magnesium alloy article from the mold.

4. The magnesium alloy article production line of claim 1, wherein the metal finishing apparatus is further configured to deburr the finished magnesium alloy article.

5. The magnesium alloy article production line of claim 1, further comprising a joining apparatus configured to bond the magnesium alloy article to a different metal article, the different metal article comprising a metal composition different than the target magnesium alloy composition.

6. The magnesium alloy article production line of claim 5, wherein the second coating apparatus is configured to coat the second coating on the magnesium alloy article bonded to the different metal article.

7. The magnesium alloy article production line of claim 1, wherein the second coating is coated over the first coating.

8. The magnesium alloy article production line of claim 1, wherein the first coating apparatus is configured to selectively coat the first coating on a first portion of the finished magnesium alloy article.

9. The magnesium alloy article production line of claim 8, wherein the second coating apparatus is configured to selectively coat the second coating on a second portion of the finished magnesium alloy article.

10. The magnesium alloy article production line of claim 9, wherein the first portion and the second portion are the same.

11. The magnesium alloy article production line of claim 1, wherein the first coating comprises a plasma electrolytic oxidation coating, a micro arc oxidation coating, a zinc phosphate coating, a fluorozirconate coating, a non-chromate conversion coating, an anodized layer, a polymeric sealant, an electrophoretic coating, a primer, a powder coating, a paint coating, an enamel coating, or a combination thereof.

12. The magnesium alloy article production line of claim 1, wherein the second coating comprises a dielectric coating.

13. The magnesium alloy article production line of claim 1, wherein the magnesium alloy article comprises an electric vehicle battery enclosure.

14. The magnesium alloy article production line of claim 1, further comprising an adaptive line controller comprising an algorithm configured to control operation of at least two of the metal breakdown apparatus, the solid particle mixing apparatus, the metal forming apparatus, the metal finishing apparatus, first coating apparatus, or the second coating apparatus based on one or more target characteristics of the magnesium alloy article,
wherein the one or more target characteristics of the magnesium alloy article are selected from the group consisting of: a target corrosion resistance, a target wear resistance, a target mechanical strength, a target flame resistance or retardance, a target mechanical ductility, a target cost point, and a combination thereof.

15. A method of manufacturing a magnesium alloy article, the method comprising:
chipping a magnesium alloy ingot into magnesium alloy pieces;
mixing the magnesium alloy pieces with one or more powdered alloying materials to provide a mixture comprising a target magnesium alloy composition;
melting the mixture comprising the target magnesium alloy composition into a molten magnesium alloy;
molding the molten magnesium alloy in a mold to form a molded magnesium alloy article;
machining the molded magnesium alloy article to create a finished magnesium alloy article;
coating at least a portion of the finished magnesium alloy article with a first coating; and
coating at least a portion of the finished magnesium alloy article with a second coating, the second coating being different from the first coating.

16. The method of claim 15, comprising:
joining the magnesium alloy article to a different metal article, the different metal article comprising a metal composition different than the target magnesium alloy composition; and
coating at least a portion of the magnesium alloy article and the different metal article with the first coating, the second coating, or both.

17. The method of claim 15, wherein the one or more powdered alloying materials comprises carbon particles.

18. The method of claim 15, wherein the one or more powdered alloying materials are selected to produce the molten magnesium alloy having target properties for the molding operation to form the molded magnesium alloy article.

19. The method of claim 15, wherein the first coating is selectively coated on a first portion of the finished magnesium alloy article, and the second coating is selectively coated on a second portion of the finished magnesium alloy article.

20. The method of claim 19, comprising masking the second portion of the finished magnesium alloy article while coating the first coating.

21. The method of claim 15, wherein the second coating is coated over the first coating.

22. The method of claim 15, wherein machining the molded magnesium alloy article comprises one or more shaping steps and one or more drilling steps, and wherein process parameters of the one or more shaping steps and the one or more drilling steps are selected based on the target magnesium alloy composition.

23. The method of claim 15, wherein the first coating and the second coating are selected based on a target surface property for a first portion of the finished magnesium alloy article.

24. The method of claim 23, wherein the target surface property is a wear resistance, a corrosion resistance, a dielectric strength, or a combination thereof.

25. The method of claim 15, wherein:
the second coating is coated over the first coating on a first portion of the finished magnesium alloy article, and
the method comprises coating a second portion of the finished magnesium alloy article with a third coating and a fourth coating coated over the third coating, and
the first coating and the second coating are selected based on a first target surface property for the first portion of the finished magnesium alloy article, and
the third coating and the fourth coating are selected based on a second target surface property for the second portion of the finished magnesium alloy article, and
the first target surface property is different than the second target surface property.

26. The method of claim 15, wherein the magnesium alloy article comprises an electric vehicle battery enclosure.
